(19) United States
(12) Patent Application Publication
(10) Pub. No.: US 2025/0131531 A1
(43) Pub. Date: Apr. 24, 2025

(54) IMAGE GENERATION DEVICE AND TELEOPERATION ASSISTANCE SYSTEM FOR WORK MACHINE

(71) Applicant: SUMITOMO HEAVY INDUSTRIES, LTD., Tokyo (JP)

(72) Inventor: Keita NAKAMORI, Kanagawa (JP)

(21) Appl. No.: 18/915,619

(22) Filed: Oct. 15, 2024

(30) Foreign Application Priority Data
Oct. 18, 2023 (JP) 2023-179460

(51) Int. Cl. G06T 5/50; G06T 7/50; G06T 7/70; G06V 10/74

(52) U.S. Cl. CPC G06T 5/50; G06T 7/50; G06T 7/70; G06V 10/761; G06T 2207/20221

(57) ABSTRACT

An image generation device generates an image for assisting teleoperation of a work machine equipped with a work attachment. The image generation device is configured to generate a composite image that includes a main image included in an image captured at a work site where the work machine works by an imaging device, and a complementary image that complements an outside of an imaging range of the main image.

### CROSS-REFERENCE TO RELATED APPLICATIONS

Priority is claimed to Japanese Patent Application No. 2023-179460, filed Oct. 18, 2023, the entire content of which is incorporated herein by reference.

### BACKGROUND

### 1. Technical Field

The present disclosure relates to an image generation device and a teleoperation assistance system for a work machine.

### 2. Description of Related Art

A teleoperation system for a work machine is known.

### SUMMARY

According to an aspect of the present disclosure, an image generation device is an image generation device that generates an image for assisting teleoperation of a work machine equipped with an attachment and that generates a composite image that includes a main image, which is included in an image captured at a work site where the work machine works by an imaging device, and a complementary image, which complements the areas outside an imaging range of the main image.

According to another aspect of the present disclosure, a teleoperation assistance system for a work machine includes a work machine equipped with an attachment and a teleoperation assistance device that assists teleoperation of the work machine, wherein the teleoperation assistance device includes the image generation device, a display device that displays the composite image generated at a location remote from a work site by the image generation device, and a teleoperation device that remotely operates the work machine working.

### BRIEF DESCRIPTION OF THE DRAWINGS

FIG. 1 is a schematic diagram illustrating an example of a teleoperation assistance system according to an embodiment of the present disclosure;

FIG. 2 is a schematic plan view illustrating an example of a work site;

FIG. 3 is a diagram illustrating an example of a composite image generated by an image generation device;

FIG. 4 is a diagram for explaining an example of a trained model;

FIG. 5 is a side view of a shovel as an example of a work machine;

FIG. 6 is a view illustrating a configuration example of a drive system mounted on the shovel of FIG. 5;

FIG. 7 is a view illustrating a configuration example of an electric system mounted on the shovel of FIG. 5;

FIG. 8 is a diagram illustrating a relationship between a coordinate system related to a teleoperation room and a coordinate system related to a shovel; and

FIG. 9 is a diagram illustrating a configuration example of a display device.

### DETAILED DESCRIPTION OF THE PRESENT DISCLOSURE

The aforementioned known teleoperation system is configured to display an image of a work site on a display device installed in a teleoperation room outside a work machine.

With this configuration, however, an image that creates a sense of presence cannot be provided to an operator who remotely operates the work machine in the teleoperation room, and there is a concern that work efficiency may be degraded.

For example, a report from Hokuriku Region Maintenance Office of Ministry of Land, Infrastructure and Transport in 2006 on improvement of operability of an unmanned construction machine points out that work efficiency in remote operation is largely influenced by a lack of visual information.

From the viewpoint of improving work efficiency, it is desirable to provide an image of a work site with a sense of presence to a remote operator of a work machine.

According to the present disclosure, it is possible to provide an image of a work site with a sense of presence to a remote operator of a work machine and thereby improve work efficiency.

Hereinafter, embodiments for carrying out the invention will be described with reference to the drawings.

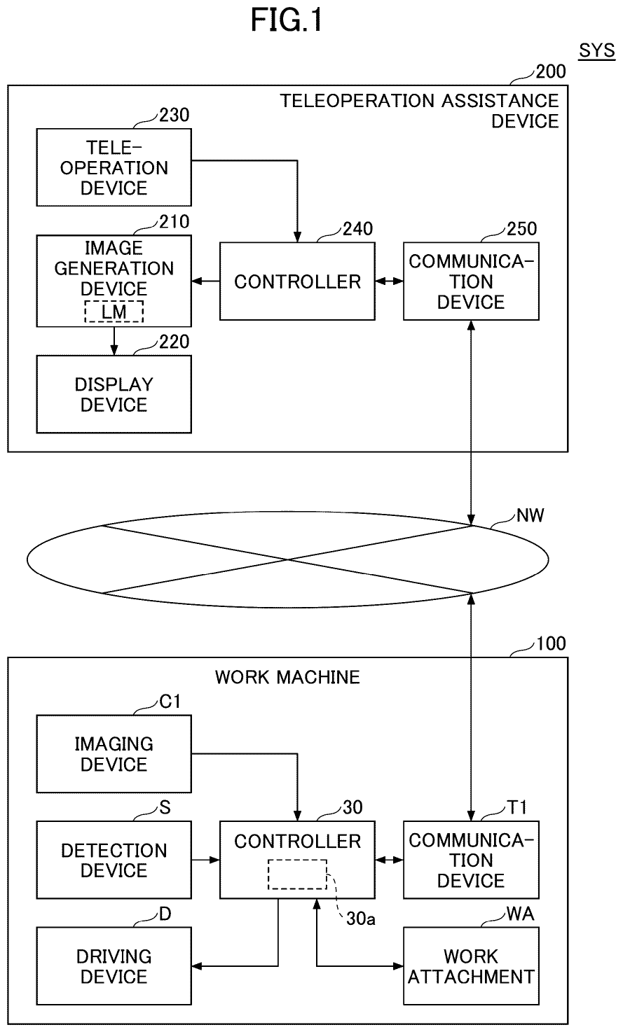

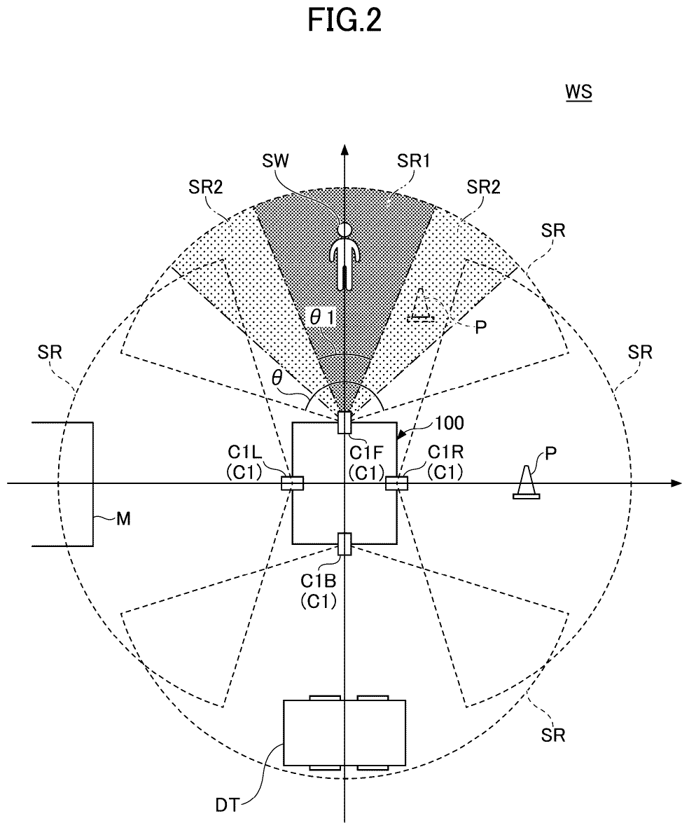

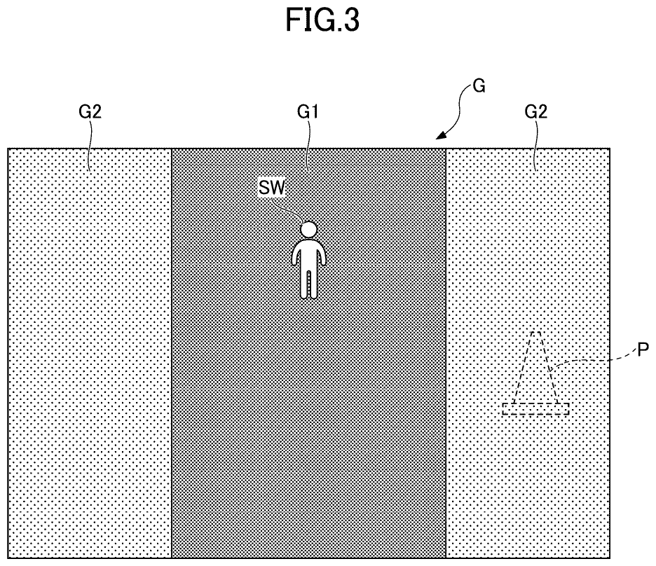

FIG. 1 is a schematic diagram illustrating an example of a teleoperation assistance system SYS according to an embodiment of the present disclosure. FIG. 2 is a schematic plan view illustrating an example of a work site WS. FIG. 3 is a diagram illustrating an example of a composite image G generated by an image generation device 210 of the present embodiment of the teleoperation assistance system SYS illustrated in FIG. 1.

Although details will be described later, an image generation device 210 of the present embodiment is a device that generates an image for assisting teleoperation of a work machine 100 equipped with a work attachment WA. The image generation device 210 generates a composite image G including a main image G1 included in an image captured at a work site WS where the work machine 100 works by an imaging device C1 and one or more complementary images G2 that complement the outside of an imaging range SR1 of the main image G1. The “complementary image” can also be referred to as an “extrapolation image”. Hereinafter, the image generation device 210 and the teleoperation assistance system SYS for a work machine according to the present embodiment will be described in detail.

As illustrated in FIG. 1, the teleoperation assistance system SYS of the present embodiment includes, for example, a work machine 100 equipped with a work attachment WA, and a teleoperation assistance device 200 that assists teleoperation of the work machine 100. The number of work machines 100 included in the teleoperation assistance system SYS may be one or more. In a case where a plurality of work machines 100 are included in the teleoperation assistance system SYS, all of the plurality of work machines 100 may be of the same type, or at least some of the plurality of work machines 100 may be of different types.

The teleoperation assistance system SYS may include a plurality of teleoperation assistance devices 200. In other words, the plurality of teleoperation assistance devices 200 may perform the processing related to the teleoperation assistance system SYS in a distributed manner. For example, each of the plurality of teleoperation assistance devices 200 may communicate with one or more work machines 100 of which the device 200 is in charge among all work machines 100 included in the teleoperation assistance system SYS, and perform processing targeting those machines 100.

The work machine 100 is a machine that performs work at a work site WS, such as a forklift, a crane, or a shovel. The work machine 100 includes, for example, an imaging device C1, a controller 30, a detection device S, a driving device D, a communication device Ti, and a work attachment WA.

The imaging device C1 is configured to capture an image of a work site WS around the work machine 100. The imaging device C1 outputs, for example, the captured image of the work site WS to the controller 30. The imaging device C1 need not be mounted on the work machine 100. The imaging device C1 may be attached to, for example, a pole installed in a work site WS or a drone flying above a work site WS.

The imaging device C1 includes, for example, one or more cameras. Specifically, the imaging device C1 includes, for example, a front camera C1F, a rear camera C1B, a right camera CR, and a left camera C1L as illustrated in FIG. 2. The imaging device C1 may include one or more stereo cameras and/or one or more monocular cameras.

The front camera C1F and the rear camera C1B are installed at the front portion and the rear portion of the machine body of the work machine 100, respectively, and capture images of the front and the rear of the work machine 100, respectively. The right camera C1R and the left camera C1L are installed on the right side and the left side of the machine body of the work machine 100, respectively, and capture images of the right side and the left side of the work machine 100, respectively. In FIG. 2, the imaging range SR of each camera is indicated by a dashed line.

In the example illustrated in FIG. 2, the imaging range SR of the front camera C1F and that of the rear camera C1B overlap the imaging range SR of the right camera C1R and that of the left camera C1L, respectively. For this reason, the imaging device C1 is configured to be able to capture an image of a work site WS in a 360-degree surrounding of the work machine 100. The imaging device C1 may be a spherical camera installed on the machine body of the work machine 100 or in an operator's cab.

The detection device S is configured to detect a physical quantity related to the work machine 100. The detection device S includes, for example, a speed sensor, an acceleration sensor, an angular velocity sensor, an inertial measurement unit (IMU), an angle sensor, a temperature sensor, a pressure sensor, a rotation speed sensor, a fuel remaining amount sensor, a urea water remaining amount sensor, and the like. The detection device S may include a receiver of a global navigation satellite system (GNSS) that detects position information of the work machine 100. The detection device S outputs a detection result of a physical quantity or position and posture information relating to the work machine 100 to the controller 30.

The driving device D is configured to drive the work machine 100. The driving device D includes, for example, an engine, a transmission, a hydraulic device (a hydraulic tank, a hydraulic pump, a control valve, a hydraulic actuator, etc.), an electric motor, and the like. The driving device D generates power for, for example, causing the work machine 100 to travel, turning the work machine 100, or operating an attachment of the work machine 100.

The communication device Ti can communicate with the teleoperation assistance device 200 through a predetermined communication line NW. The communication device Ti outputs a control signal received from the teleoperation assistance device 200 via the communication line NW to the controller 30. The communication device Ti also functions as a transmission device that transmits various kinds of information including a main image G1 and position and posture information of the work machine 100 that are input from the controller 30 to the teleoperation assistance device 200 via the communication line NW.

The work attachment WA is, for example, a device for the work machine 100 to perform work at a work site WS, and is controlled by the controller 30 based on remote operation by a remote operator. In the case where the work machine 100 is a forklift, the work attachment WA includes, for example, a fork, a backrest, a lift chain, a mast, and the like. In the case where the work machine 100 is a crane, the work attachment WA includes, for example, a boom, a jib, a hook, a guy line, and the like. In the case where the work machine 100 is a shovel, the work attachment WA is, for example, an excavation attachment including a boom, an arm, a bucket, and the like.

The communication line NW includes, for example, a wide area network (WAN). The wide area network may include, for example, a mobile communication network where a base station serves as a terminal. The wide area network may include, for example, a satellite communication network that uses a communication satellite above the work machine 100. The wide area network may include, for example, the Internet. The communication line NW may include, for example, a local area network (LAN) of a facility or the like in which the teleoperation assistance device 200 is installed. The local network may be a wireless network, a wired network, or a combination thereof. The communication line NW may include a short-range communication network based on a predetermined wireless communication scheme such as WiFi or Bluetooth (registered trademark).

The controller 30 is a calculation device that executes various calculations. In the present embodiment, the controller 30 is configured by a microcomputer including a central processing unit (CPU) and a memory 30a. The various functions of the controller 30 are realized by the CPU executing a program stored in the memory 30a.

The controller 30 extracts, for example, a part of an image captured by the imaging device C1 at a work site WS, and generates a main image G1 to be transmitted to the teleoperation assistance device 200. As illustrated in FIG. 2, a wide angle of view θ in the camera constituting the imaging device C1 results in a greater distortion in the peripheral portion of the image. For this reason, as illustrated in FIGS. 2 and 3, the controller 30 extracts, for example, a main image G1, namely an image of an imaging range SR1 of the imaging range SR of a camera constituting the imaging device C1, which corresponds to a predetermined angle of view θ1 around the optical axis of the camera.

The angle of view θ1 of the imaging range SR1 of the main image G1 is, for example, a range of about 20° to 30° around the optical axis of the camera constituting the imaging device C1, which corresponds to the central visual field or the effective visual field of a human being. In other words, if the angle of view θ of the camera constituting the imaging device C1 is wider than the range from 20° to 30°, the controller 30 extracts a main image G1, which is a part of an entire image of the imaging range SR, and transmits the main image G1 to the teleoperation assistance device 200 via the communication device Ti. This makes it possible to reduce the amount of image data compared to a case where the image of the entire imaging range SR is transmitted to the teleoperation assistance device 200.

The controller 30 can also transmit an image with less distortion from the work machine 100 to the teleoperation assistance device 200 by extracting, from the image of the entire imaging range SR captured by the imaging device C1 at a work site WS, a main image G1 of the imaging range SR1 that has an angle of view θ1 corresponding to the central visual field or the effective visual field of a human being. If the angle of view θ of the imaging device C1 is a relatively narrow angle of, for example, about 20° to 30°, the distortion of the image of the entire imaging range SR is small. In this case, the controller 30 may extract the image of the entire imaging range SR of the imaging device C1 as the main image G1 and transmit it to the teleoperation assistance device 200 via the communication device Ti.

As illustrated in FIG. 1, the teleoperation assistance device 200 includes an image generation device 210, a display device 220, and a teleoperation device 230. The teleoperation assistance device 200 also includes, for example, a controller 240 and a communication device 250. The teleoperation assistance device 200 can communicate with the work machine 100 via the communication device 250 through a predetermined communication line NW.

The image generation device 210 and the controller 240 are, for example, arithmetic devices that execute various kinds of arithmetic operations. In the present embodiment, the image generation device 210 and the controller 240 are each configured by a microcomputer including a CPU and a memory. The various functions of the image generation device 210 and the controller 240 are realized by the CPU executing the program stored in the memory. The image generation device 210 and the controller 240 may be configured by separate microcomputers or may be configured by a shared microcomputer.

As described above, the image generation device 210 generates an image for assisting a remote operation of the work machine 100 equipped with the work attachment WA. The image generation device 210 generates a composite image G that includes a main image G1 included in an image captured at a work site WS where the work machine 100 works by the imaging device C1, and a complementary image G2 that complements the areas outside the imaging range SR1 of the main image G1. Specifically, the complementary image G2 is, for example, an image that complements the areas SR2 adjacent to the left and right of the imaging area SR1 of the main image G1, as illustrated in FIG. 2. The complementary image G2 may be an image that complements the areas vertically adjacent to the imaging range SR1 of the main image G1. The complementary image G2 is, for example, not an image captured by the imaging device C1, but an image that is created by the image generation device 210 and complements the areas outside the imaging range SR of the imaging device C1 or the imaging range SR1 of the main image G1.

The main image G1 is, for example, an image to be displayed in the central visual field or the effective visual field of a remote operator. The complementary image G2 is, for example, an image to be displayed in the peripheral visual field of a remote operator. The difference between the feature of the main image G1 and the feature of the complementary image G2 is equal to or less than a predetermined threshold. Herein, it is desirable that the predetermined threshold is set within a range in which, for example, a remote operator who remotely operates the work machine 100 while looking at the main image G1 of the composite image G cannot recognize a difference between the actual image of the areas SR2 captured by the imaging device C1 and the complementary image G2. The actual image of the areas SR2 need not be transmitted from the work machine 100 to the teleoperation assistance device 200.

The features of the main image G1 and the complementary image G2 include, for example, an RGB value, chromaticity, brightness, saturation, and the like for each pixel or unit area of each image. The features of the main image G1 and the complementary image G2 may be derived by an algorithm, such as scale-invariant feature transform (SIFT) or histograms of oriented gradients (HOG). The features of the main image G1 and the complementary image G2 may be obtained by digitizing a color distribution in the image, or may be a local feature obtained by detecting a feature point having a large change in density in the image by a feature point detection method and converting an area around the feature point into a feature vector by a pixel value or a differential value. The complementary image G2 includes, for example, an image of one color which is the same color as the color of the main image G1 periphery portion adjacent to the complementary image G2, an illustration image, a CG image, and the like. The complementary image G2 may include, for example, an image obtained by correcting distortion of an image captured by the imaging device C1.

The image generation device 210 includes, for example, a trained model LM in which images including an image of the areas outside the imaging range SR1 captured by the imaging device C1 and a main image G1 are learned as training data. The image generation device 210 generates a composite image G by inputting a main image G1 to the trained model 1M, for example. The image of the areas outside the imaging range SR1 of the main image G1 that is included in the training data may be an image captured by the imaging device C1 in the past (one minute before, etc.) or an image of another work site similar to the work site WS. The trained model 1M may be generated by unsupervised learning.

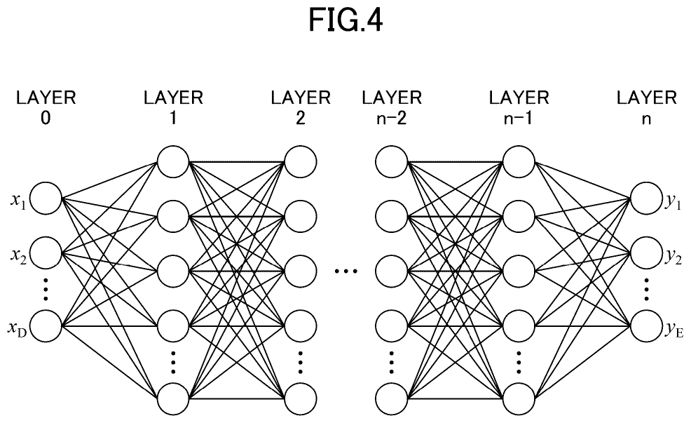

FIG. 4 is a diagram illustrating an example of the trained model 1M. As machine learning used for generating the trained model LM, for example, deep learning is applied, which is machine learning using a deep neural network (DNN). The trained model LM outputs a composite image G from an input layer (layer 0) of the neural network by inputting a main image G1 to the input layer (layer n). The image generation device 210 may generate a composite image G including a main image G1 and a complementary image G2 by using a method such as generative adversarial networks (GAN), TF-GAN, DeepFill, Pconv, or Boundless.

The image generation device 210 generates a training dataset using, for example, a plurality of main images G1 accumulated in a nonvolatile storage device of the controller 240 during the operation of the work machine 100 and the position and posture information of the work machine 100 corresponding to each main image G1. The image generation device 210 generates the trained model 1M by performing machine learning using the generated teacher data set, for example.

The image generation device 210 generates a complementary image G2 that includes an image of an object based on, for example, the information of the object recognized from an image captured at the work site WS by the imaging device C1 and the position and posture information of the work machine 100 working at the work site WS. Specifically, for example, as illustrated in FIG. 2, suppose a worker SW, a cone P, a truck DT, and another work machine M are present at 0°, 90°, 180°, 270° respectively, where the front direction of the work machine 100 is defined as 0°, the right direction is defined as 90°, the rear direction is defined as 180°, and the left direction is defined as 270° (the angle setting method can be discretionarily chosen).

In this case, the image generation device 210 recognizes objects, such as the worker SW, the cone P, the truck DT, and another work machine M, in the image captured by the imaging device C1 by a known method such as pattern matching. Furthermore, the image generation device 210 stores object information in which a recognition result of the objects is associated with the position and posture information of the work machine 100 at the time of capturing those objects by the imaging device C1 in a nonvolatile storage device such as a ROM constituting the image generation device 210. The object information may be stored in a volatile storage device that constitutes the image generation device 210, such as a RAM.

The image generation device 210 then compares the current position and posture information of the work machine 100 with the object information stored in a nonvolatile storage device, and in the case where an object is present in either one of the areas SR2 corresponding to a complementary image G2 to be generated, generates an image of the object, and displays the image superimposed on the complementary image G2. Specifically, as illustrated in FIG. 2, in the case where a cone P is present in either of the areas SR2 for which a complementary image G2 to be generated, the image generation device 210 generates the complementary image G2 including an image of the cone P as illustrated in FIG. 3.

Herein, the “image of the cone P” is typically an image unrelated to the actual image of the cone P captured by the imaging device C1 (an image generated by the image generation device 210 without being based on the actual image of the cone P). However, the “image of the cone P” may be an image generated by the image generation device 210 based on an actual image of the cone P captured by the imaging device C1 in the past. The complementary image G2 including the image of the object may be generated by inputting a keyword representing the object recognized in the image of the imaging device C1 to the image generation device 210.

There is a case, for example, where a part of the work machine 100, such as the work attachment WA, to be specific, a fork of a forklift, a boom of a crane, or an attachment (a boom, an arm, or an end attachment) of a shovel, is present in either of the areas SR2 of the work site WS corresponding to the complementary image G2. In such a case, the image generation device 210 may generate the complementary image G2 including an image of a part of the work machine 100 based on, for example, the shape, the dimensions, and the posture of the work machine 100 that performs work in the work site WS and the positional relationship between the work machine 100 and the imaging device C1. In this case, the image generation device 210 may use, for example, CAD data, such as a 3D model of the work machine 100 stored in advance in a nonvolatile storage device.

The display device 220 includes a display, such as a liquid crystal display, an organic EL display, or a head mounted display, and displays the composite image G that is input from the image generation device 210. The display device 220 provides the composite image G of the work site WS to a remote operator who operates the work machine 100 via the teleoperation device 230 installed at a remote location away from the work site WS.

The teleoperation device 230 is, for example, a device that simulates the driver's seat or the operator's seat of the work machine 100, and includes an operation device and an output device similar to those installed in the driver's seat or the operator's seat of the work machine 100. Specifically, the operation device of the teleoperation device 230 includes, for example, an operation lever, an operation pedal, an operation dial, an operation button, a touch panel, and the like. The output device of the teleoperation device 230 includes, for example, a monitor, a speaker, and a buzzer. The operation device of the teleoperation device 230 includes, for example, a sensor that detects an operation of the remote operator, and outputs, to the controller 240, a control signal in accordance with an operation of the remote operator.

The controller 240 outputs, for example, a control signal that is input from the teleoperation device 230 to the communication device 250. Further, for example, the main image G1 transmitted from the work machine 100 and received by the communication device 250 is input from the communication device 250 to the controller 240. The controller 240 outputs, to the image generation device 210, the main image G1 that is input from the communication device 250.

The communication device 250 can communicate with the work machine 100 via a predetermined communication line NW. The communication device 250 transmits, for example, to the work machine 100 via the communication line NW, a control signal that is input from the controller 240. The communication device 250 also functions as a receiver device that receives, at a remote location away from the work site WS, various kinds of information including the main image G1 and the position and posture information of the work machine 100 transmitted from the work machine 100 in the work site WS by wireless communication, and outputs the information to the image generation device 210 via the controller 240.

Hereinafter, the advantageous effect of the image generation device 210 and the teleoperation assistance system SYS for a work machine of the present embodiment will be described.

As described above, the image generation device 210 of the present embodiment is a device that generates an image for assisting teleoperation of the work machine 100 equipped with a work attachment WA. The image generation device 210 generates a composite image G including a main image G1 included in an image captured at a work site WS where the work machine 100 works by the imaging device C1 and a complementary image G2 that complements the areas outside the imaging range SR1 of the main image G1.

With this configuration, it is possible to generate a composite image G by extracting a portion with little distortion around the optical axis of the imaging device C1 as a main image G1 from an image captured at the work site WS by the imaging device C1. On the other hand, among the images captured at the work site WS by the imaging device C1, an image of the areas SR2 outside the imaging range SR1 of the main image G1 tends to have a larger distortion than the main image G1. For this reason, it is possible to avoid deterioration of a sense of presence due to the above-described distortion in the image of the areas SR2 by generating, with the image generation device 210, a composite image G that includes a complementary image G2 for complementing the areas SR2 outside the imaging range SR1 of the main image G1. Since at least one of the main image G1 or the complementary image G2 includes an image of a work attachment WA, it is possible to further improve the sense of presence of a composite image G and to improve the operability of the remote operation of the work machine 100. Therefore, according to the image generation device 210 of the present embodiment, it is possible to provide an image of the work site WS with an enhanced sense of presence to a remote operator who operates the work machine 100 at a remote location away from the work site WS, and to improve work efficiency.

In the image generation device 210 of the present embodiment, the complementary image G2 is an image that complements the areas SR2 that are leftward and rightward of the imaging range SR1 of the main image G1.

With this configuration, it is possible to generate a composite image G including a complementary image G2 that complements the areas SR2 adjacent to the imaging range SR1 of a main image G1 in a turning direction of the work machine 100, such as a forklift, a crane, or an excavator. It is thus possible to provide, in response to turn of the work machine 100, a remote operator with a composite image G with an enhanced sense of presence that is attained by complementing an image of a turning direction of the main image G1 with a complementary image G2.

The image generation device 210 of the present embodiment includes a trained model LM in which images including an image of the areas outside the imaging range SR1 captured at a work site WS by the imaging device C1 and a main image G1 are learned as training data. Then, the image generation device 210 inputs the main image G1 to the trained model LM to generate a composite image G.

With this configuration, it is possible to reduce a difference between a feature of an image with little distortion obtained by capturing the areas SR2 from the front by the imaging device C1 and a feature of a complementary image G2 as much as possible, and to reduce a difference between a feature of a main image G1 and a feature of a complementary image G2 as much as possible. As a result, the difference in the features between the actual image of the areas SR2 captured from the front by the imaging device C1 and the complementary image G2 can be reduced to such an extent that a remote operator who remotely operates the work machine 100 while looking at a main image G1 of a composite image G cannot recognize the difference between the actual image and the complementary image G2, and the sense of presence of the composite image G can be improved.

The image generation device 210 of the present embodiment generates a complementary image G2 including an image of an object based on information of the object recognized in an image captured at a work site WS by the imaging device C1 and the position and posture information of the work machine 100 performing work at the work site WS.

With this configuration, it is possible to display images of objects that may be present around the work machine 100 in the work site WS, such as a worker SW, a cone P, a truck DT, and another work machine M, on a complementary image G2, and to provide a composite image G with an enhanced sense of presence. From the viewpoint of improving security, the object detection around the work machine 100 can be performed by using a sensor other than the imaging device C1 in combination.

The image generation device 210 of the present embodiment generates a complementary image G2 that includes an image of the work machine 100 based on a shape, dimensions, and posture of the work machine 100 performing work at the work site WS, and the positional relationship between the work machine 100 and the imaging device C1.

With this configuration, for example, in the case where a part of the work machine 100, such as a fork of a forklift, a boom of a crane, or an attachment of a shovel, is present in either of the areas SR2 of the work site WS corresponding to a complementary image G2, the part can be displayed in the complementary image G2. Thus, a composite image G with an enhanced sense of presence can be provided to a remote operator who operates the work machine 100 at a remote location away from the work site WS.

In the image generation device 210 of the present embodiment, the difference between the feature quantity of the main image G1 and the feature quantity of the complementary image G2 is equal to or less than a predetermined threshold.

With this configuration, a difference in the feature between an actual image of the areas SR2 captured from the front by the imaging device C1 and a complementary image G2 can be reduced to such an extent that a remote operator who remotely controls the work machine 100 while looking at a main image G1 of a composite image G cannot recognize the difference between the actual image and the complementary image G2, and a sense of presence of the composite image G can be improved.

The teleoperation assistance system SYS for a work machine according to the present embodiment includes the work machine 100 equipped with a work attachment WA and the teleoperation assistance device 200 that assists a remote operation of the work machine 100. The teleoperation assistance device 200 includes the image generation device 210 described above, a display device 220 that displays a composite image G generated at a remote location away from the work site WS by the image generation device 210, and the teleoperation device 230 that operates the work machine 100 that works at the work site WS from the remote location.

With this configuration, it is possible to cause the display device 220 installed at a remote location away from a work site WS to display a composite image G of the work site WS with an enhanced sense of presence. At least one of a main image G1 or a complementary image G2 included in a composite image G can include an image of a work attachment WA of the work machine 100. This makes it possible to improve the work efficiency of a remote operator who remotely operates the work machine 100 at the work site WS equipped with a work attachment WA by operating the teleoperation device 230 installed at a remote location while looking at the composite image G displayed on the display device 220. It is advantageous to use a head mounted display as the display device 220 from the viewpoint of improvement of resolution in the central visual field or the effective visual field of the operator OP and prevention of motion sickness that the operator OP may suffer from looking at a composite image G.

The work machine 100 constituting the teleoperation assistance system SYS for a work machine according to the present embodiment includes the communication device Ti as a transmitter device that transmits a main image G1 from the work site WS by wireless communication. The teleoperation assistance device 200 constituting the teleoperation assistance system SYS further includes a communication device 250 as a receiver device that receives at a remote location a main image G1 transmitted from the transmission device of the work machine 100 and outputs the main image G1 to the image generation device 210 installed at the remote location.

With this configuration, in a case where the imaging range SR1 of the main image G1 is narrower than the imaging range SR of the imaging device C1, the data amount of the main image G1 can be reduced to be smaller than the data amount of the entire image of the imaging range SR of the imaging device C1. As a result, it is possible to reduce the amount of data transmitted for transmitting a main image G1 from the transmitter device at the work site WS to the receiver device at the remote location to a greater degree compared to the case where the entire image of the imaging range SR of the imaging device C1 is transmitted, and to reduce required communication bandwidth in turn.

As described above, with the image generation device 210 and the teleoperation assistance system SYS for a work machine according to the present embodiment, it is possible to provide a composite image G of a work site WS with a sense of presence to a remote operator of the work machine 100 and to improve the work efficiency.

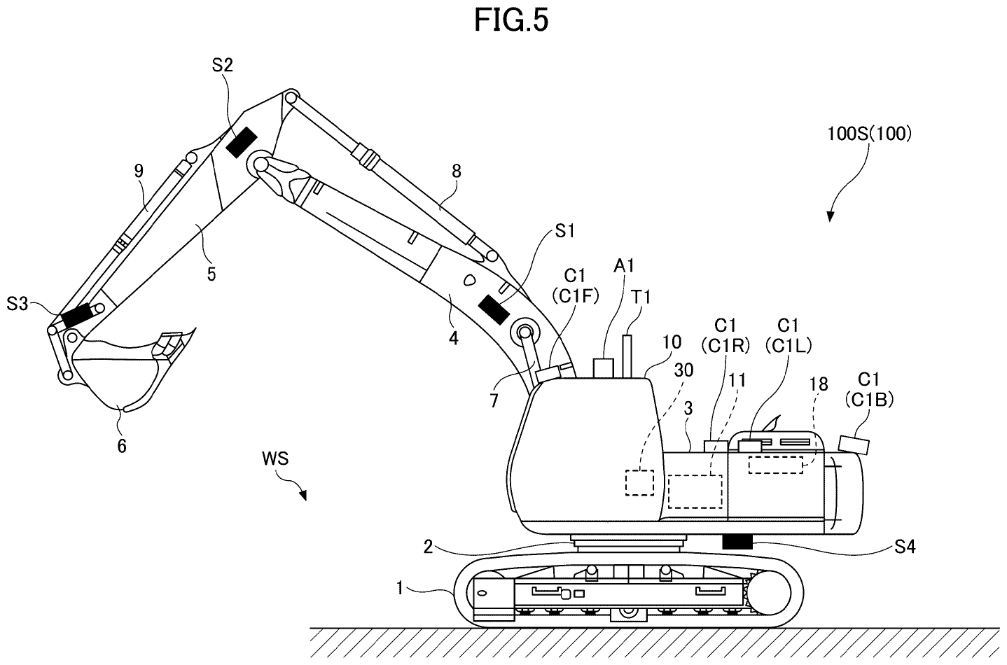

Hereinafter, an example in which the image generation device 210 and the teleoperation assistance system SYS for a work machine according to the present embodiment are applied to a shovel, which is an example of the work machine 100, will be described with reference to FIGS. 5 through 9.

FIG. 5 is a side view of a shovel 100S as an example of the work machine 100. An upper swing structure 3 is swingably mounted on a lower travel structure 1 of the shovel 100S via a swing mechanism 2. A boom 4 is attached to the upper swing structure 3. An arm 5 is attached to the distal end of the boom 4, and a bucket 6 as an end attachment is attached to the distal end of the arm 5.

The boom 4, the arm 5, and the bucket 6 constitute an excavation attachment, which is an example of the work attachment WA. The boom 4 is driven by a boom cylinder 7, the arm 5 is driven by an arm cylinder 8, and the bucket 6 is driven by a bucket cylinder 9.

A boom angle sensor S1 is attached to the boom 4, an arm angle sensor S2 is attached to the arm 5, and a bucket angle sensor S3 is attached to the bucket link. A swing angular speed sensor S4 is attached to the upper swing structure 3.

The boom angle sensor S1 is a type of attitude detection sensors, and is configured to detect a rotation angle of the boom 4. In the present embodiment, the boom angle sensor S1 is a stroke sensor that detects a stroke amount of the boom cylinder 7, and derives a rotation angle of the boom 4 around a boom foot pin that couples the upper swing structure 3 and the boom 4 based on the stroke amount of the boom cylinder 7.

The arm angle sensor S2 is a type of posture detection sensors, and is configured to detect a rotation angle of the arm 5. In the present embodiment, the arm angle sensor S2 is a stroke sensor that detects a stroke amount of the arm cylinder 8, and derives the rotation angle of the arm 5 around a coupling pin that couples the boom 4 to the arm 5 based on the stroke amount of the arm cylinder 8.

The bucket angle sensor S3 is a type of attitude detection sensors, and is configured to detect the rotation angle of the bucket 6. In the present embodiment, the bucket angle sensor S3 is a stroke sensor that detects the stroke amount of the bucket cylinder 9, and derives the rotation angle of the bucket 6 around a coupling pin that couples the arm 5 and the bucket 6 based on the stroke amount of the bucket cylinder 9.

The swing angular speed sensor S4 is configured to detect a swing angular speed of the upper swing structure 3. In the present embodiment, the turning angular speed sensor S4 is a gyro sensor. The turning angular speed sensor S4 may be configured to calculate the turning angle based on the turning angular speed. The turning angular speed sensor S4 may be configured by a different type of sensor, such as a rotary encoder.

The upper swing structure 3 is provided with a cab 10 as a driver's cab, an engine 11, a positioning device 18, a sound collecting device A1, an imaging device C1, a communication device Ti, and the like. A controller is installed in the cabin 10. A driver's seat, an operation device, and the like are set up in the cabin 10. Alternatively, the shovel 100S may be an unmanned excavator in which the cabins 10 are omitted.

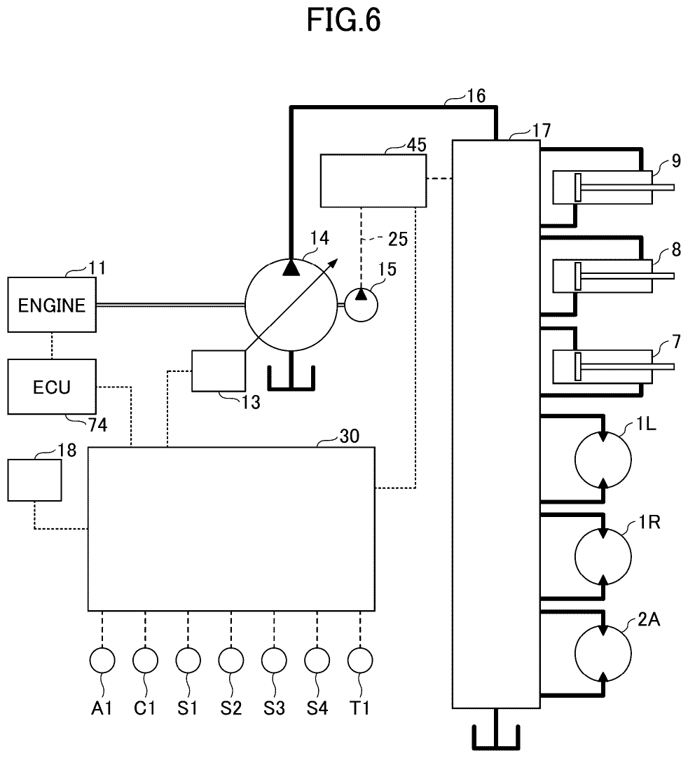

The engine 11 is a drive source of the shovel 100S. In the present embodiment, the engine 11 is a diesel engine. An output shaft of the engine 11 is coupled to respective input shafts of a main pump 14 and a pilot pump (see FIG. 6).

The positioning device 18 is configured to measure the position of the shovel 100S. In the present embodiment, the positioning device 18 is a GNSS compass and is configured to be able to measure the position and orientation of the upper swing structure 3.

The sound collector A1 is configured to collect sound generated around the shovel 100S. In the present embodiment, the sound collecting device A1 is a microphone attached to the upper swing structure 3.

The imaging device C1 is configured to image the surroundings of the shovel 100S. In the present embodiment, the imaging device C1 includes a rear camera C1B attached to the rear end of the upper surface of the upper swing structure 3, a front camera CiF attached to the front end of the upper surface of the cab 10, a left camera C1L attached to the left end of the upper surface of the upper swing structure 3, and a right camera C1R attached to the right end of the upper surface of the upper swing structure 3. The imaging device C1 may be a spherical camera installed at a predetermined position in the cabin 10. The predetermined position is, for example, a position corresponding to the position of the eyes of the operator seated on the driver's seat installed in the cabin 10.

The communication device Ti is configured to control communication with a device outside the shovel 100S. In the present embodiment, the communication device Ti is configured to control wireless communication between the communication device Ti and a device outside the shovel 100S via a wireless communication network. As described above, the controller 30 is a calculation device that executes various calculations.

FIG. 6 is a block diagram illustrating an example of the configuration of a drive system mounted on the shovel 100S of FIG. 5. In FIG. 6, the mechanical power transmission line is indicated by a double line, the hydraulic fluid line is indicated by a thick solid line, the pilot line is indicated by a broken line, and the electric control line is indicated by a dotted line.

The drive system of the shovel 100S is constituted by the engine 11, a regulator 13, a main pump 14, a pilot pump 15, a control valve group 17, a controller 30, a solenoid valve group 45, and the like. The engine 11 is controlled by an engine control unit 74.

The main pump 14 supplies the hydraulic oil to the control valve group 17 via the hydraulic oil line 16. In the present embodiment, the main pump 14 is a swashplate-type variable displacement hydraulic pump.

The regulator 13 is configured to control the discharge amount of the main pump 14. In the present embodiment, the regulator 13 is configured to adjust the swashplate tilt angle of the main pump 14 in accordance with the discharge pressure of the main pump 14, a control signal from the controller 30, or the like. The main pump 14 is controlled by the regulator 13 in terms of the discharge amount (displacement volume) per rotation.

The pilot pump 15 is configured to supply a hydraulic oil to various types of hydraulic control devices via a pilot line 25. In the present embodiment, the pilot pump 15 is a fixed displacement hydraulic pump. However, the pilot pump 15 may be omitted. In this case, the function of the pilot pump 15 may be realized by the main pump 14. In other words, the main pump 14 may have a function of supplying a hydraulic oil to the solenoid valve group 45 or the like via a throttle or the like, separately from the function of supplying a hydraulic oil to the control valve group 17.

The control valve group 17 is configured to be able to selectively supply a hydraulic oil received from the main pump 14 to one or a plurality of hydraulic actuators. In the present embodiment, the control valve group 17 includes a plurality of control valves corresponding to the plurality of hydraulic actuators. The control valve group 17 is configured to be able to selectively supply a hydraulic oil discharged from the main pump 14 to one or a plurality of hydraulic actuators. The hydraulic actuator includes, for example, a boom cylinder 7, an arm cylinder 8, a bucket cylinder 9, a left traveling hydraulic motor 1L, a right traveling hydraulic motor 1R, and a turning hydraulic motor 2A.

The controller 30 is configured to control the solenoid valve group 45 based on an operation signal received through the communication device Ti. In the present embodiment, the operation signal is transmitted from a remote operation room at a remote location away from the work site WS. The operation signal may be generated by an operation device provided in the cab 10.

The solenoid valve group 45 includes a plurality of solenoid valves respectively disposed in the pilot lines connecting the pilot pump 15 to the respective pilot ports of the control valves in the control valve group 17.

In this way, the controller 30 can realize the raising and lowering of the boom 4, the opening and closing of the arm 5, the opening and closing of the bucket 6, the swing of the upper swing structure 3, the travel of the lower travel structure 1, and the like, in response to an externally supplied operation signal, such as a signal from a remote operation room. In other words, in the shovel 100S, the drive system illustrated in FIG. 6 constitutes the driving device D in the work machine 100 illustrated in FIG. 1.

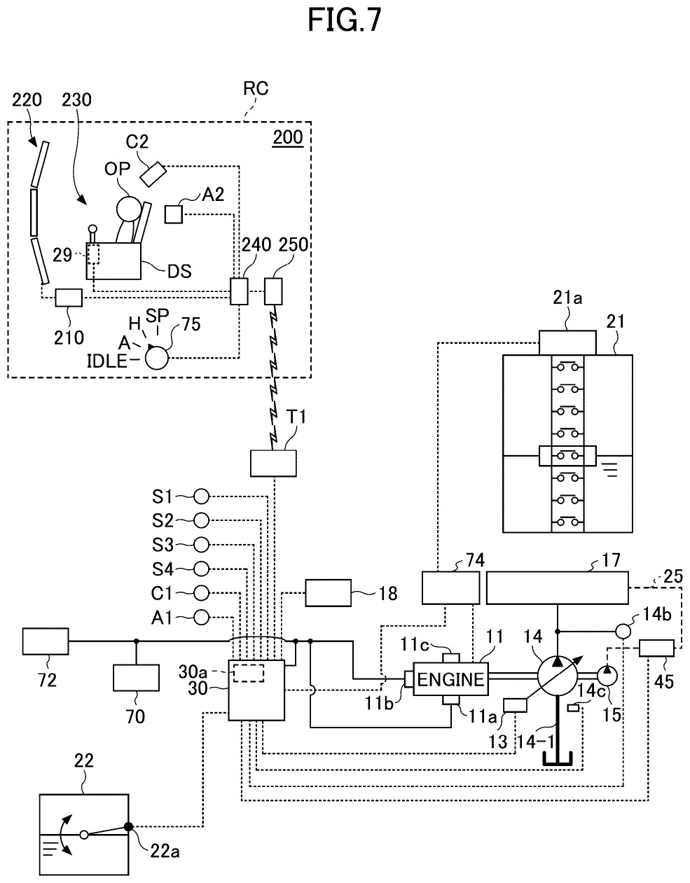

FIG. 7 is a block diagram illustrating an example of the configuration of an electric system installed on the shovel 100S of FIG. 5. As illustrated in FIG. 6, the engine 11 is connected to the engine control unit 74. Various data indicating the state of the engine 11 is transmitted from the engine control unit 74 to the controller 30. The controller 30 is configured to store various information indicating the state of the engine 11 in the memory 30a.

A battery 70 is configured to supply electric power to various electric loads installed on the shovel 100S. An alternator 11a (generator), a starter 11b, the controller 30, an electrical component 72, and the like are configured to operate with electric power stored in the battery 70. The starter 11b is driven by electric power stored in the battery 70 and configured to start the engine 11. The battery 70 is configured to be charged with electric power generated by the alternator 11a.

A water temperature sensor 11c transmits data regarding the temperature of the engine coolant to the controller 30. The regulator 13 transmits data regarding the swashplate tilt angle to the controller 30. A discharge pressure sensor 14b transmits data regarding the discharge pressure of the main pump 14 to the controller 30. The positioning device 18 transmits the position of the shovel 100S to the controller 30.

An oil temperature sensor 14c is provided in a pipe line 14-1 between the main pump 14 and a hydraulic fluid tank in which a hydraulic fluid suctioned by the main pump 14 is stored. The oil temperature sensor 14c transmits to the controller 30 data regarding the temperature of a hydraulic fluid flowing through the pipe line 14-1.

A urea water remaining amount sensor 21a provided in a urea water tank 21 transmits data regarding the remaining amount of urea water to the controller 30. A fuel level sensor 22a provided in a fuel tank 22 transmits data regarding the level of fuel to the controller 30.

In the shovel 100S, the boom angle sensor S1, the arm angle sensor S2, the bucket angle sensor S3, the swing angular speed sensor S4, the water temperature sensor iic, the discharge pressure sensor 14b, the oil temperature sensor 14c, the urea water remaining amount sensor 21a, and the fuel remaining amount sensor 22a constitute a detection device S in the work machine 100 of FIG. 1.

The communication device Ti is configured to transmit and receive information to and from the communication device 250 constituting the teleoperation assistance device 200 installed in the remote operation room RC via wireless communication. In the present embodiment, the communication device Ti and the communication device 250 are configured to transmit and receive information via a fifth-generation mobile communication line (5G line), an LTE line, a satellite line, or the like.

In the remote operation room RC, a sound outputting device A2, an indoor imaging device C2, a teleoperation assistance device 200, and the like are installed. The teleoperation assistance device 200 includes the image generation device 210, the display device 220, the teleoperation device 230, the controller 240, the communication device 250, and the like. In the remote operation room RC, a driver's seat DS for an operator OP who remotely controls the shovel 100S to sit is provided. The image generation device 210 and the controller 240 are arithmetic devices that execute various kinds of arithmetic operations as described above.

The sound outputting device A2 is configured to output a sound. In the present embodiment, the sound outputting device A2 is a speaker and is configured to reproduce sound collected by the sound collecting device A1 attached to the shovel 100S.

The indoor imaging device C2 is configured to image the inside of the remote operation room RC. In the present embodiment, the indoor imaging device C2 is a camera installed inside the remote operation room RC, and is configured to image an operator OP seated on the driver's seat DS.

The communication device 250 is configured to control wireless communication with a communication device Ti attached to the shovel 100S.

In the present embodiment, the driver's seat DS has a structure similar to that of a driver's seat installed in a cabin of a normal shovel. Specifically, a left console box is disposed on the left side of the driver's seat DS, and a right console box is disposed on the right side of the driver's seat DS. A left operation lever is disposed at the front end of the upper surface of the left console box, and a right operation lever is disposed at the front end of the upper surface of the right console box. A travel lever and a travel pedal are disposed in front of the driver's seat DS. Furthermore, an engine speed adjustment dial 75 is disposed at the center of the upper surface of the right console box. The left operation lever, the right operation lever, the travel lever, the travel pedal, and the engine speed adjustment dial 75 constitute the teleoperation device 230.

The engine speed adjustment dial 75 is a dial for adjusting the speed of the engine 11, and is configured to be able to switch the engine speed in four stages, for example.

Specifically, the engine speed adjustment dial 75 is configured to be able to switch the engine speed in four stages of an SP mode, an H mode, an A mode, and an idling mode. The engine speed adjustment dial 75 transmits data regarding the setting of the engine speed to the controller 30.

The SP mode is a rotation speed mode selected in the case where an operator OP wants to prioritize the work amount, and uses the highest engine rotation speed. The H mode is a rotation speed mode selected in the case where an operator OP wants to achieve both the work amount and the fuel efficiency, and the mode uses the second highest engine rotation speed. The A mode is a rotation speed mode selected in the case where an operator OP wants to operate the shovel with low noise while giving priority to fuel efficiency, and the mode uses the third highest engine rotation speed. The idling mode is a rotation speed mode selected in the case where an operator OP wants to set the engine to an idling state, and the mode uses the lowest engine rotation speed. The engine 11 is controlled to rotate at a constant speed in the speed mode selected by the engine speed adjustment dial 75.

The teleoperation device 230 is provided with an operation sensor 29 for detecting an operation performed by the teleoperation device 230. The operation sensor 29 is, for example, an inclination sensor that detects an inclination angle of the operation lever, an angle sensor that detects a swing angle of the operation lever around a swing axis, or the like. The operation sensor 29 may be configured by another sensor such as a pressure sensor, a current sensor, a voltage sensor, or a distance sensor. The operation sensor 29 outputs information regarding the detected operation performed by the teleoperation device 230 to the controller 240. The controller 240 generates an operation signal based on the received information and transmits the generated operation signal to the shovel 100S. The operation sensor 29 may be configured to generate an operation signal. In this case, the operation sensor 29 may output the operation signal to the communication device 250 without passing through the controller 240.

The display device 220 is configured to display information about the surrounding situation of the shovel 100S. In the present embodiment, the display device 220 is a multi-display including nine monitors arranged in three rows and three columns, and is configured to be able to display the states of the spaces in front of, on the left of, and on the right of the shovel 100S. Each monitor is a liquid crystal monitor, an organic EL monitor, or the like. However, the display device 220 may be configured by one or a plurality of curved surface monitors, or may be configured by a projector.

The display device 220 may be a wearable display device that can be worn by an operator OP. For example, the display device 220 may be a head mounted display and may be configured to be able to transmit and receive information to and from the controller 240 by wireless communication. The head mounted display may be connected to the controller 240 by a wire. The head mounted display may be a transmissive head mounted display or a non-transmissive head mounted display. The head mounted display may be a monocular head mounted display or a binocular head mounted display.

The display device 220 is configured to display an image that allows an operator OP in the remote operation room RC to visually recognize the surroundings of the shovel 100S. In other words, the display device 220 displays an image so that the operator who is in the remote operation room RC can check the situation around the shovel 100S as if the operator were in the cab 10 of the shovel 100S.

As described above, the image generation device 210 is a device that generates an image for assisting a remote operation of the shovel 100S as the work machine 100 equipped with an excavation attachment as the work attachment WA. The image generation device 210 generates a composite image G that includes a main image G1 included in an image captured at the work site WS where the shovel 100S works by the imaging device C1 and a complementary image G2 that complements the areas outside the imaging range SR1 of the main image G1. The display device 220 displays an image at least partially including a composite image G generated by the image generation device 210.

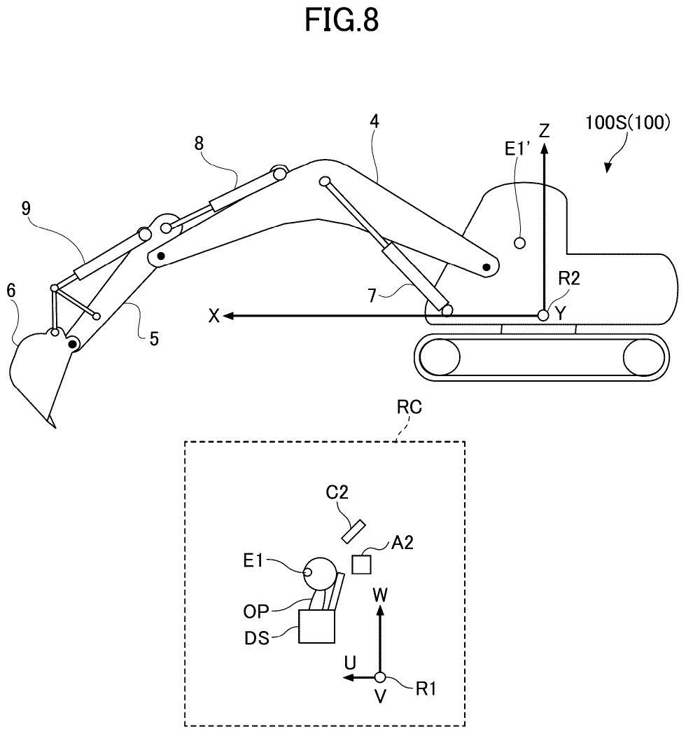

Next, a relationship between a first coordinate system having a reference point R1 in the remote operation room RC as an origin and a second coordinate system having a reference point R2 in the shovel 100S as an origin will be described with reference to FIG. 8. In the following description, the first coordinate system is referred to as an “operation room coordinate system”, and the second coordinate system is referred to as a “shovel coordinate system”. FIG. 8 is a diagram illustrating a relationship between the operation room coordinate system and the shovel coordinate system.

The operation room coordinate system is a three-dimensional UVW orthogonal coordinate system having a reference point R1 in the remote operation room RC as an origin, and has a U-axis extending in parallel to the front-rear direction of the driver's seat DS, a V-axis extending in parallel to the left-right direction of the driver's seat DS, and a W-axis orthogonal to the U-axis and the V-axis.

The shovel coordinate system is a three-dimensional XYZ-orthogonal coordinate system having a reference point R2 on the upper swing structure 3 as an origin, and has an X-axis extending in parallel to the front-rear direction of the upper swing structure 3, a Y-axis extending in parallel to the left-right direction of the upper swing structure 3, and a Z-axis orthogonal to the X-axis and the Y-axis. In the example of FIG. 8, the reference point R2 is a point on the turning shaft, the XY plane is a horizontal plane, and the Z-axis is a vertical axis. In other words, in the example of FIG. 8, the ground contact surface which is a virtual plane on which the shovel 100S is positioned is a horizontal plane. The X-axis corresponds to a U-axis of the operation room coordinate system, the Y-axis corresponds to a V-axis of the operation room coordinate system, and the Z-axis corresponds to a W-axis of the operation room coordinate system.

In the present embodiment, each of the three-dimensional coordinates in the operation room coordinate system is associated with one of the three-dimensional coordinates in the shovel coordinate system in advance. For this reason, if the three-dimensional coordinate of an operator viewpoint E1, which is the eye position of an operator OP in the remote operation room RC, is determined, the three-dimensional coordinate of a virtual operator viewpoint E1′, which is the position of the eyes of a virtual operator in the shovel 100S, is uniquely determined. The eye position of an operator OP is, for example, the middle point between the position of the left eye and the position of the right eye of the operator OP. However, the eye position of the operator OP may be a predetermined position. In other words, the operator viewpoint E1 and the virtual operator viewpoint E1′ may be fixed points.

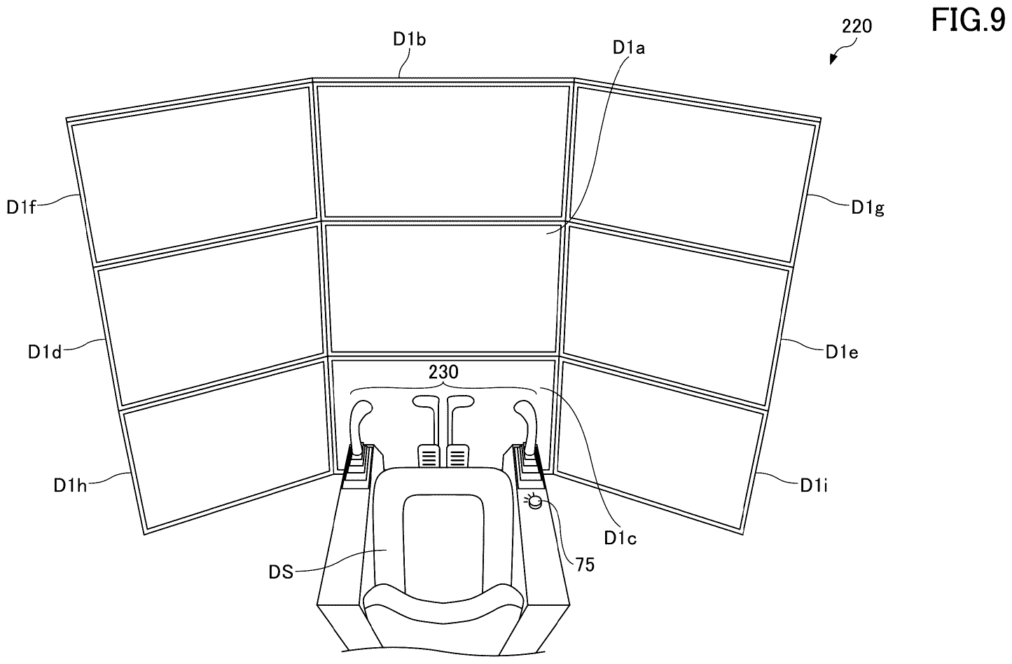

FIG. 9 is a diagram illustrating a configuration example of the display device 220. As illustrated in FIG. 9, the display device 220 is a multi-display including nine monitors arranged in three rows and three columns. Specifically, the display device 220 includes a central monitor D1a, an upper monitor D1b, a lower monitor D1c, a left monitor D1d, a right monitor D1e, an upper left monitor D1f, an upper right monitor D1g, a lower left monitor D1h, and a lower right monitor D1i.

The display device 220 displays a main image G1, which is described hereinbefore with reference to FIGS. 2 and 3, on at least a part of the central monitor D1a, the upper monitor D1b, and the lower monitor D1c corresponding to the central visual field of the operator OP in the remote operation room RC, for example. The display device 220 displays a complementary image G2, which is described hereinbefore with reference to FIGS. 2 and 3, on at least a part of the left monitor D1d, the right monitor D1e, the upper left monitor D1f, the upper right monitor D1g, the lower left monitor D1h, and the lower right monitor D1i corresponding to the peripheral visual field of an operator OP in the remote operation room RC, for example.

With this configuration, a portion, from an image captured at a work site WS by the imaging device C1 attached to the shovel 100S, with little distortion around the optical axis of the imaging device C1 can be displayed as a main image G1 in the central visual field of an operator OP in the remote operation room RC. A complementary image G2 for complementing the areas SR2 outside the imaging range SR1 of a main image G1 can be displayed in the peripheral visual field of the operator OP in the remote operation room RC. At least one of a main image G1 or a complementary image G2 may include an image of the excavation attachment of the shovel 100S. As a result, it is possible to provide an image of the work site WS with an enhanced sense of presence to the operator OP operating the shovel 100S equipped with the excavation attachment at a remote location away from the work site WS, and to improve the workability of the shovel 100S.

The preferred embodiments of the present invention have been described in detail above. However, the present invention is not limited to the above-described embodiment. Various modifications, substitutions, and the like can be applied to the above-described embodiment without departing from the scope of the present invention. Also, features that have been described separately can be combined as long as no technical contradiction arises.

For example, in the above-described embodiment, the example in which the image generation device is installed at a remote location away from a work site has been described. However, the image generation device may be mounted on the work machine. In this case, a composite image generated by the image generation device can be transmitted from the work machine at the work site, received at a remote location where the teleoperation device is installed, and displayed on the display device.

The image generation device may generate a composite image without using machine learning. The image generation device may extract, for example, a past image captured by the imaging device accumulated in association with position and posture information of the work machine according to current position and posture information of the work machine, and display the extracted image as a complementary image.

What is claimed is:

1. An image generation device configured to generate an image for assisting teleoperation of a work machine equipped with a work attachment, the image generation device comprising:
a memory; and
a processor coupled to the memory and configured to generate a composite image that includes
a main image included in an image captured at a work site where the work machine works by an imaging device, and
a complementary image that complements an outside of an imaging range of the main image.

2. The image generation device according to claim 1, wherein
the complementary image is an image that complements areas that are leftward and rightward of the imaging range of the main image.

3. The image generation device according to claim 1, wherein
the image generation device includes a trained model trained with images as training data, the image including
an image of an outside of the imaging range of the main image, the image being captured at the work site by the imaging device, and
the main image, and
the processor is configured to generate the composite image in response to an input of the main image to the trained model.

4. The image generation device according to claim 1, wherein
the complementary image that includes an image of an object is generated based on information regarding the object and position and posture information of the work machine that works at the work site, the object being recognized in the image captured at the work site by the imaging device.

5. The image generation device according to claim 1, wherein
the complementary image that includes an image of the work machine is generated based on a shape, dimensions, and a posture of the work machine that works at the work site and a positional relationship between the work machine and the imaging device.

6. The image generation device according to claim 1, wherein
a difference between a feature of the main image and a feature of the complementary image is equal to or less than a predetermined threshold.

7. A teleoperation assistance system for a work machine, the teleoperation assistance system comprising:
a memory;
a processor coupled to the memory;
a work machine equipped with a work attachment; and
a teleoperation assistance device configured to assist a remote operation of the work machine, wherein
the teleoperation assistance device includes
the image generation device of claim 1;
a display device configured to display the composite image generated at a remote location away from the work site by the image generation device; and
a teleoperation device configured to operate, from the remote location, the work machine that works at the work site.

8. The teleoperation assistance system for the work machine according to claim 7, wherein
the work machine includes a transmitter device configured to
transmit the main image from the work site by wireless communication, and
the teleoperation assistance device further includes a receiver device configured to
receive at the remote location the main image transmitted from the transmitter device, and
output the main image to the image generation device arranged at the remote location.
